(19) United States
(12) Patent Application Publication
(10) Pub. No.: US 2009/0127818 A1
(43) Pub. Date: May 21, 2009

(54) Bicycle Damping Device That Provides A Damping Effect to the Bicycle when the Bicycle Travels Downhill

(76) Inventor: Tsan-Lin Chang, Yuanlin Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/235,953

(22) Filed: Sep. 23, 2008

(30) Foreign Application Priority Data
Nov. 15, 2007 (TW) 096219295

(51) Int. Cl. B62L 1/04; B62L 3/02; B62K 3/00

(52) U.S. Cl. 280/270; 280/288.4; 188/25

(57) ABSTRACT

A bicycle includes a frame, a wheel mounted on the frame, a handlebar mounted on the frame, a damping device mounted on the frame and movable to touch the wheel, a control switch mounted on the handlebar, and a connecting wire mounted on the frame and connected between the control switch and the damping device to control movement of the damping device by operation of the control switch. Thus, when the bicycle travels downhill and the rear wheel is rotated at a higher speed, the damping device provides a damping force on the rear wheel to reduce the rotation speed of the rear wheel so as to prevent the rear wheel from being rotated at an excessive high speed when traveling downhill, thereby protecting the rider's safety.

### BACKGROUND OF THE INVENTION

1. Field of the Invention

The present invention relates to a damping device and, more particularly, to a damping device for a bicycle.

2. Description of the Related Art

A conventional brake device for a bicycle comprises a front brake mounted on the front wheel of the bicycle and a rear brake mounted on the rear wheel of the bicycle. Thus, the front brake and the rear brake are operated to brake the front wheel and the rear wheel of the bicycle so as to slow down or stop the bicycle. However, the front wheel and the rear wheel of the bicycle are rotated at a very high speed when the bicycle travels downhill, so that the front brake and the rear brake cannot brake the front wheel and the rear wheel of the bicycle efficiently, thereby easily causing danger to the rider.

### BRIEF SUMMARY OF THE INVENTION

In accordance with the present invention, there is provided a bicycle, comprising a frame, a wheel mounted on the frame, a handlebar mounted on the frame, a damping device movably mounted on the frame and movable to touch the wheel to provide a damping effect to the wheel, a control switch mounted on the handlebar, and a connecting wire mounted on the frame and connected between the control switch and the damping device to control movement of the damping device by operation of the control switch.

The primary objective of the present invention is to provide a bicycle damping device that provides a damping effect to the bicycle when the bicycle travels downhill.

Another objective of the present invention is to provide a damping device for a bicycle, wherein when the bicycle travels downhill and the rear wheel is rotated at a higher speed, the damping device provides a damping force on the rear wheel to reduce the rotation speed of the rear wheel so as to prevent the rear wheel from being rotated at an excessive high speed when traveling downhill, thereby protecting the rider's safety.

A further objective of the present invention is to provide a damping device for a bicycle, wherein when the rear wheel is rotated at a higher speed, the damping device provides a damping force on the rear wheel so as to reduce the rotation speed of the rear wheel, and when the rear wheel is rotated at a lower speed, the damping force applied on the rear wheel is removed, so that the rear wheel is rotated at a constant speed.

A further objective of the present invention is to provide a damping device for a bicycle, wherein when the bicycle travels downhill and the rear wheel is rotated at a lower speed, the damping device will not provide a damping force on the rear wheel, so that the rear wheel is rotated smoothly and stably.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a bicycle in accordance with the preferred embodiment of the present invention.

FIG. 2 is a locally enlarged rear view of the bicycle as shown in FIG. 1.

FIG. 3 is a perspective view of a damping device of the bicycle as shown in FIG. 1.

FIG. 4 is an exploded perspective view of the damping device of the bicycle as shown in FIG. 3.

FIG. 5 is a front broken view of the damping device of the bicycle as shown in FIG. 3.

FIG. 6 is a schematic operational view of the bicycle as shown in FIG. 2.

FIG. 7 is a schematic operational view of the damping device of the bicycle as shown in FIG. 5.

### DETAILED DESCRIPTION OF THE INVENTION

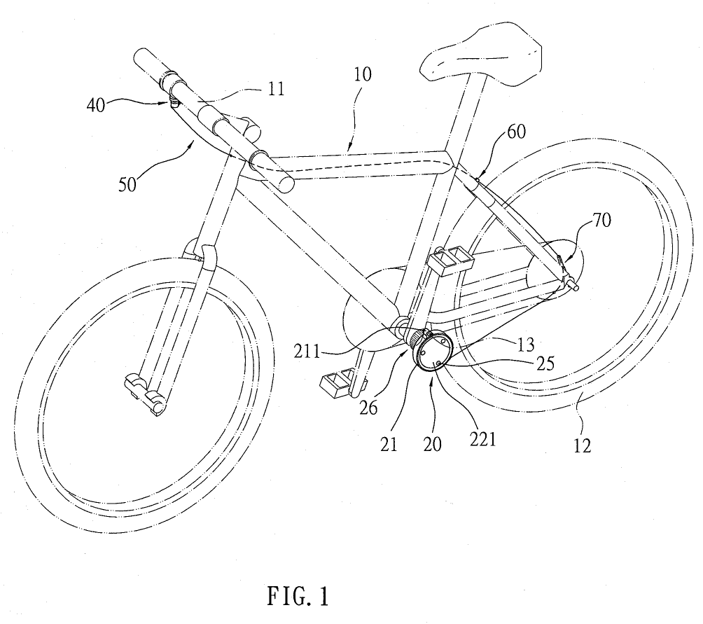

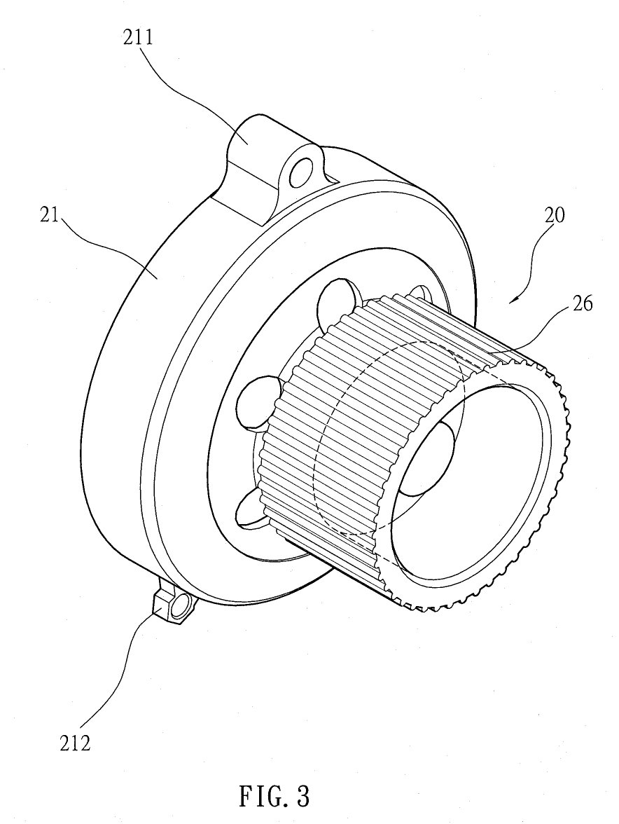

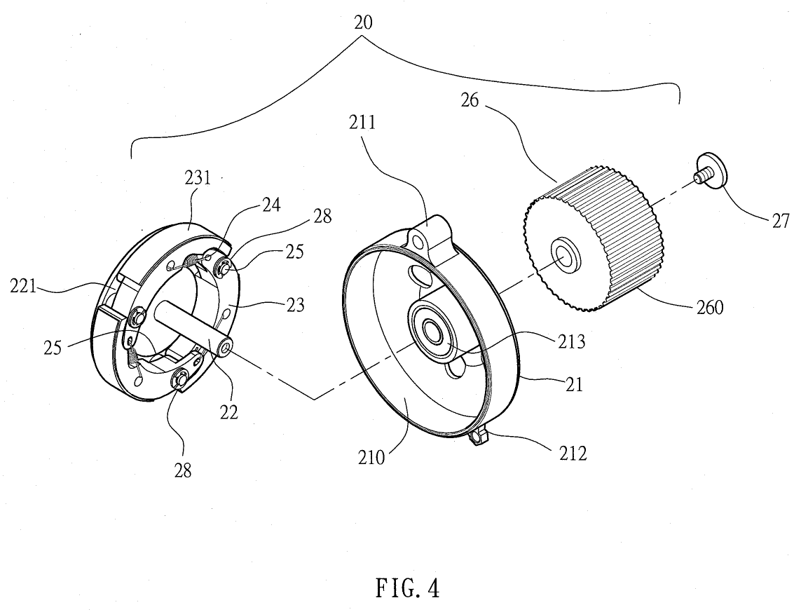

Referring to the drawings and initially to FIGS. 1-5, a bicycle in accordance with the preferred embodiment of the present invention comprises a frame 10, a rear wheel 12 mounted on the frame 10, a handlebar 11 mounted on the frame 10, a damping device 20 movably mounted on the frame 10 and movable to touch the rear wheel 12 to provide a damping effect to the rear wheel 12, a control switch 40 mounted on the handlebar 11, a connecting wire 50 mounted on the frame 10 and connected between the control switch 40 and the damping device 20 to control movement of the damping device 20 by operation of the control switch 40, a plurality of retaining rings 60 mounted on the frame 10 and encompassing the connecting wire 50 to limit the connecting wire 50 on the frame 10, and an adjusting unit 70 mounted on the frame 10 and connected with the connecting wire 50 to adjust a distance between the damping device 20 and the rear wheel 12.

The frame 10 is provided with a support rod 13 located in front of the rear wheel 12 to support the damping device 20.

The damping device 20 includes a housing 21 pivotally mounted on the frame 10 and movable relative to the rear wheel 12, a friction wheel 26 mounted on the housing 21 to move in concert with the housing 21 and movable to touch the rear wheel 12, a spindle 22 rotatably mounted in the housing 21 and having a first end secured in and rotated by the friction wheel 26, a mounting plate 221 secured on a second end of the spindle 22 to rotate in concert with the spindle 22, a plurality of damping shoes 23 each movably mounted on the mounting plate 221 to rotate in concert with the mounting plate 221 and each movable relative to the housing 21 to press an inner wall 210 of the housing 21 and to stop rotation of the spindle 22 and the friction wheel 26 so as to provide a damping effect to the rear wheel 12, a plurality of pivot shafts 25 each secured on the mounting plate 221 and each extending through a respective one of the damping shoes 23, and a plurality of return springs 24 biased between the damping shoes 23.

The housing 21 of the damping device 20 is a hollow cylinder and has an inner portion provided with a bearing 213 mounted on the spindle 22. The housing 21 of the damping device 20 has a periphery having a first side provided with a pivot portion 211 pivotally mounted on the support rod 13 of the frame 10 and a second side provided with a driven portion 212. The connecting wire 50 has a first end mounted on and driven by the control switch 40 and a second end mounted on the driven portion 212 of the housing 21 to drive the housing 21 of the damping device 20 to pivot about the support rod 13 of the frame 10 and to move relative to the rear wheel 12.

The spindle 22 of the damping device 20 extends through a central portion of the bearing 213 of the housing 21 and is rotatable in the bearing 213 of the housing 21. The spindle 22 of the damping device 20 extends through a central portion of the friction wheel 26. The first end of the spindle 22 of the damping device 20 protrudes outwardly from the housing 21 and is secured in the friction wheel 26 by a fastening member 27. The mounting plate 221 of the damping device 20 has a circular shape and is hidden in the housing 21.

The friction wheel 26 of the damping device 20 is located outside of the housing 21 and is spaced from the rear wheel 12 at a normal state. The friction wheel 26 of the damping device 20 has a periphery provided with a serrated friction portion 260 that is movable to touch the rear wheel 12.

Each of the damping shoes 23 of the damping device 20 is pivotally mounted on and is retained on a respective one of the pivot shafts 25 by a retaining snap 28. Each of the damping shoes 23 of the damping device 20 is movable to press the inner wall 210 of the housing 21 by a high-speed rotation of the mounting plate 221 relative to the housing 21. Each of the damping shoes 23 of the damping device 20 has a substantially arc-shaped profile. Each of the damping shoes 23 of the damping device 20 has a side provided with a damping lining 231 that is movable to press the inner wall 210 of the housing 21. The damping lining 231 of each of the damping shoes 23 has a substantially arc-shaped profile and is spaced from the inner wall 210 of the housing 21. The damping shoes 23 of the damping device 20 are hidden in the housing 21 and are connected serially to form a cylindrical post surrounding the spindle 22. Each of the damping shoes 23 of the damping device 20 has two opposite ends for mounting two of the return springs 24. Each of the two opposite ends of each of the damping shoes 23 is connected with another one of the damping shoes 23 by a respective one of the return springs 24.

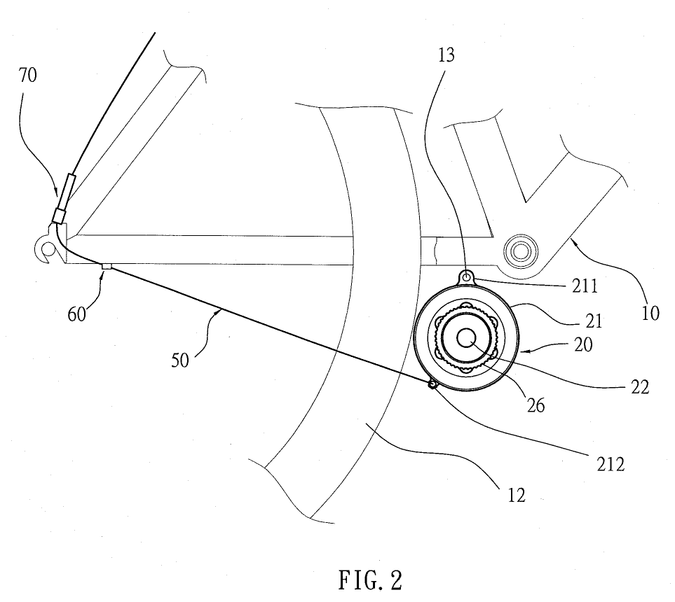

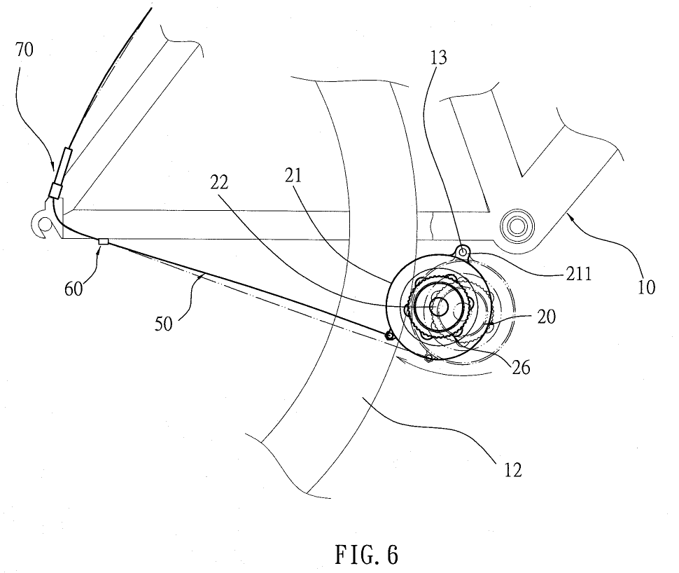

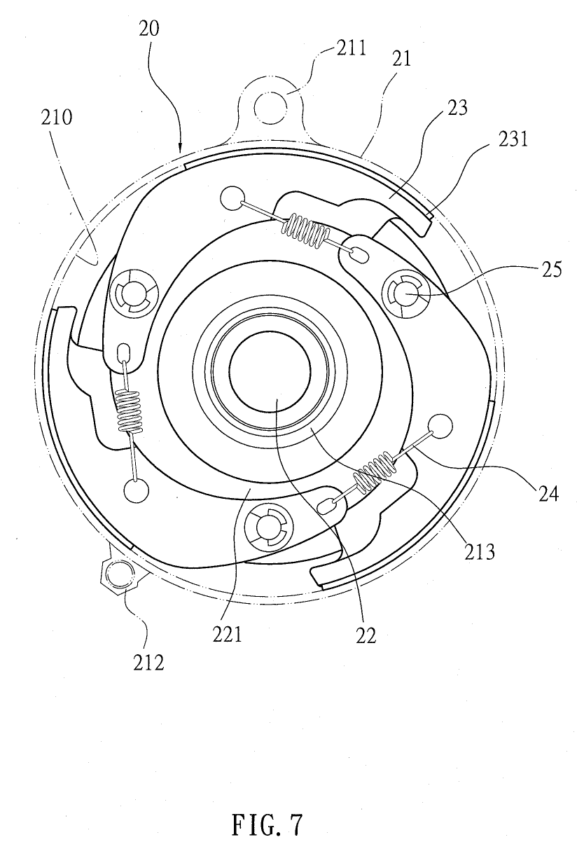

In operation, referring to FIGS. 6 and 7 with reference to FIGS. 1-5, the friction wheel 26 of the damping device 20 is spaced from the rear wheel 12 at a normal state as shown in FIG. 2. When the control switch 40 is operated, the connecting wire 50 is driven by the control switch 40 to drive the housing 21 of the damping device 20 to pivot about the support rod 13 of the frame 10 and to move from the position as shown in FIG. 2 to the position as shown in FIG. 6, so that the friction wheel 26 of the damping device 20 is movable to touch the rear wheel 12. In such a manner, when the rear wheel 12 is rotated, the friction wheel 26 of the damping device 20 is rotated to rotate the spindle 22 which rotates the mounting plate 221 which rotates the damping shoes 23 so that the damping shoes 23 are rotated about the pivot shafts 25 to produce a centrifugal force.

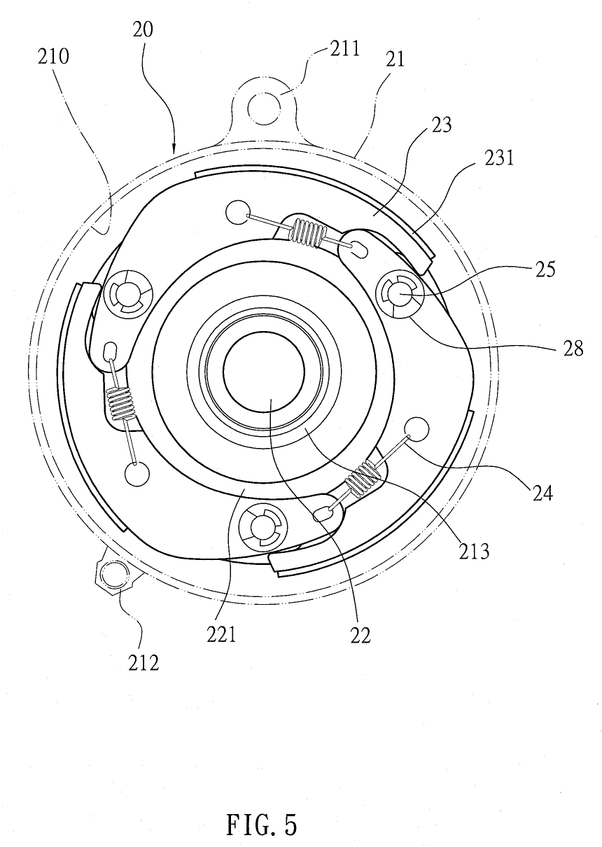

When the rear wheel 12 is rotated at a higher speed during traveling downhill, the damping shoes 23 are also rotated at a higher speed until the centrifugal force produced by the damping shoes 23 overcomes the elastic force of the return springs 24, so that the damping lining 231 of each of the damping shoes 23 is movable outwardly from the position as shown in FIG. 5 to the position as shown in FIG. 7 to press the inner wall 210 of the housing 21 and to stop rotation of the spindle 22 and the friction wheel 26 so as to provide a damping effect to the rear wheel 12, thereby reducing the rotation speed of the rear wheel 12.

When the rotation speed of the rear wheel 12 is reduced to a determined value, the rear wheel 12 is rotated at a smaller speed, and the damping shoes 23 are also rotated at a smaller speed until the elastic force of the return springs 24 overcomes the centrifugal force produced by the damping shoes 23, so that the damping lining 231 of each of the damping shoes 23 is movable inwardly from the position as shown in FIG. 7 to the position as shown in FIG. 5 to detach from the inner wall 210 of the housing 21.

In such a manner, the spindle 22 and the friction wheel 26 proceed to rotate so as to release the damping effect from the rear wheel 12, so that the rear wheel 12 is rotated successively. Thus, when the rear wheel 12 is rotated at a higher speed, the damping device 20 provides a damping force on the rear wheel 12 so as to reduce the rotation speed of the rear wheel 12, and when the rear wheel 12 is rotated at a lower speed, the damping force applied on the rear wheel 12 is removed, so that the rear wheel 12 is rotated at a constant speed.

When the damping device 20 is not in use, the control switch 40 is operated, and the connecting wire 50 is driven by the control switch 40 to drive the housing 21 of the damping device 20 to pivot about the support rod 13 of the frame 10 and to move from the position as shown in FIG. 6 to the position as shown in FIG. 2, so that the friction wheel 26 of the damping device 20 is movable to space from the rear wheel 12.

Accordingly, when the bicycle travels downhill and the rear wheel 12 is rotated at a higher speed, the damping device 20 provides a damping force on the rear wheel 12 to reduce the rotation speed of the rear wheel 12 so as to prevent the rear wheel 12 from being rotated at an excessive high speed when traveling downhill, thereby protecting the rider's safety. In addition, when the rear wheel 12 is rotated at a higher speed, the damping device 20 provides a damping force on the rear wheel 12 so as to reduce the rotation speed of the rear wheel 12, and when the rear wheel 12 is rotated at a lower speed, the damping force applied on the rear wheel 12 is removed, so that the rear wheel 12 is rotated at a constant speed. Further, when the bicycle travels downhill and the rear wheel 12 is rotated at a lower speed, the damping device 20 will not provide a damping force on the rear wheel 12, so that the rear wheel 12 is rotated smoothly and stably.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A bicycle, comprising:
a frame;
a wheel mounted on the frame;
a handlebar mounted on the frame;
a damping device movably mounted on the frame and movable to touch the wheel to provide a damping effect to the wheel;
a control switch mounted on the handlebar;
a connecting wire mounted on the frame and connected between the control switch and the damping device to control movement of the damping device by operation of the control switch.

2. The bicycle of claim 1, wherein the damping device includes:
a housing pivotally mounted on the frame and movable relative to the wheel;
a friction wheel mounted on the housing to move in concert with the housing and movable to touch the wheel;
a spindle rotatably mounted in the housing and having a first end secured in and rotated by the friction wheel;
a mounting plate secured on a second end of the spindle to rotate in concert with the spindle;
a plurality of damping shoes each movably mounted on the mounting plate to rotate in concert with the mounting plate and each movable relative to the housing to press an inner wall of the housing and to stop rotation of the spindle and the friction wheel so as to provide a damping effect to the wheel.

3. The bicycle of claim 2, wherein the damping device further includes:
a plurality of return springs biased between the damping shoes.

4. The bicycle of claim 2, wherein the damping device further includes:
a plurality of pivot shafts each secured on the mounting plate and each extending through a respective one of the damping shoes.

5. The bicycle of claim 2, wherein
the frame is provided with a support rod located in front of the wheel to support the damping device;
the housing of the damping device has a periphery having a first side provided with a pivot portion pivotally mounted on the support rod of the frame and a second side provided with a driven portion;
the connecting wire has a first end mounted on and driven by the control switch and a second end mounted on the driven portion of the housing to drive the housing of the damping device to pivot about the support rod of the frame and to move relative to the wheel.

6. The bicycle of claim 2, wherein each of the damping shoes of the damping device has a side provided with a damping lining that is movable to press the inner wall of the housing.

7. The bicycle of claim 2, wherein the housing of the damping device is a hollow cylinder.

8. The bicycle of claim 2, wherein
the housing of the damping device has an inner portion provided with a bearing mounted on the spindle;
the spindle of the damping device extends through a central portion of the bearing of the housing and is rotatable in the bearing of the housing.

9. The bicycle of claim 2, wherein the spindle of the damping device extends through a central portion of the friction wheel.

10. The bicycle of claim 2, wherein the first end of the spindle of the damping device protrudes outwardly from the housing and is secured in the friction wheel by a fastening member.

11. The bicycle of claim 2, wherein the mounting plate of the damping device has a circular shape and is hidden in the housing.

12. The bicycle of claim 2, wherein the friction wheel of the damping device is located outside of the housing and is spaced from the wheel at a normal state.

13. The bicycle of claim 2, wherein the friction wheel of the damping device has a periphery provided with a serrated friction portion that is movable to touch the wheel.

14. The bicycle of claim 4, wherein each of the damping shoes of the damping device is pivotally mounted on and is retained on a respective one of the pivot shafts by a retaining snap.

15. The bicycle of claim 2, wherein each of the damping shoes of the damping device has a substantially arc-shaped profile.

16. The bicycle of claim 6, wherein the damping lining of each of the damping shoes has a substantially arc-shaped profile and is spaced from the inner wall of the housing.

17. The bicycle of claim 2, wherein the damping shoes of the damping device are hidden in the housing and are connected serially to form a cylindrical post surrounding the spindle.

18. The bicycle of claim 3, wherein
each of the damping shoes of the damping device has two opposite ends for mounting two of the return springs;
each of the two opposite ends of each of the damping shoes is connected with another one of the damping shoes by a respective one of the return springs.

19. The bicycle of claim 2, wherein each of the damping shoes of the damping device is movable to press the inner wall of the housing by a rotation of the mounting plate relative to the housing.

20. The bicycle of claim 1, wherein the friction wheel of the damping device is rotated by the wheel to rotate the spindle which rotates the mounting plate which rotates the damping shoes.
